(19) United States
(12) Patent Application Publication
(10) Pub. No.: US 2023/0063883 A1
(43) Pub. Date: Mar. 2, 2023

(54) BATTERY PACK INCLUDING BATTERY MODULES STACKED IN MULTIPLE STAGES

(71) Applicant: LG ENERGY SOLUTION, LTD., Seoul (KR)

(72) Inventors: Soon Chang HONG, Daejeon (KR); Hyong Seok YOO, Daejeon (KR); So Eun RHIM, Daejeon (KR); Dong Hyun KIM, Daejeon (KR)

(73) Assignee: LG ENERGY SOLUTION, LTD., Seoul (KR)

(21) Appl. No.: 17/797,659

(22) PCT Filed: Jun. 1, 2021
(86) PCT No.: PCT/KR2021/006795

§ 371 Date: Aug. 4, 2022

(30) Foreign Application Priority Data
Jun. 8, 2020 (KR) 10-2020-0069078

(51) Int. Cl. H01M 10/6557; H01M 10/613; H01M 10/625; H01M 10/653

(52) U.S. Cl. CPC H01M 10/6557; H01M 10/613; H01M 10/625; H01M 10/653; H01M 2220/20

(57) ABSTRACT

A battery pack includes battery modules stacked in multiple stages, and more particularly at least one battery module and a pack case configured to receive the battery module therein, wherein the battery module includes a first battery module and a second battery module vertically stacked above the first battery module, a first cooling unit configured to discharge heat generated from the first battery module is located between an inside upper surface of the bottom surface of the pack case and the first battery module, and a second cooling unit configured to discharge heat generated from the second battery module is provided between the first battery module and the second battery module.

### TECHNICAL FIELD

This application claims the benefit of priority to Korean Patent Application No. 2020-0069078 filed on Jun. 8, 2020, the disclosure of which is incorporated herein by reference in its entirety.

The present invention relates to a battery pack including battery modules stacked in multiple stages, and more particularly to a battery pack including battery modules stacked in multiple stages configured such that a plurality of cooling units configured to discharge heat generated from the battery modules stacked in multiple stages is provided, the cooling units are protected, and refrigerant leakage is minimized.

### BACKGROUND ART

With recent development of alternative energies due to air pollution and energy depletion caused as the result of use of fossil fuels, demand for secondary batteries capable of storing electrical energy that is produced has increased. The secondary batteries, which are being capable of being charged and discharged, are intimately used in daily life. For example, the secondary batteries are used in mobile devices, electric vehicles, and hybrid electric vehicles.

Required capacities of secondary batteries used as energy sources of various kinds of electronic devices inevitably used in modern society have been increased due to an increase in usage of mobile devices, increasing complexity of the mobile devices, and development of electric vehicles. In order to satisfy demand of users, a plurality of battery cells is disposed in a small-sized device, whereas a battery module including a plurality of battery cells electrically connected to each other or a battery pack including a plurality of battery modules is used in a vehicle.

In the battery module or the battery pack, a plurality of battery cells is connected to each other in series or in parallel in order to increase capacity and output of the battery module or the battery pack. In the case in which a plurality of battery cells is used in a state of being connected to each other, a problem, such as overload, may occur. In particular, for the battery pack, battery modules, each of which includes a plurality of battery cells, are located in a case so as to be stacked in multiple stages. As a result, there is a problem in that temperature in the battery pack increases due to overload, whereby abnormality of the battery is amplified. In order to solve this problem, it is necessary for a general battery pack to have a cooling unit capable of lowering the temperature of the battery, whereby safety of the battery is improved, space efficiency of the battery is improved, and energy density of the battery is improved.

FIG. 1 is a perspective view of a conventional battery module. As shown in FIG. 1, the conventional battery module includes a module case 20 configured to receive battery cells 10 therein, a cooling channel 30 located at the upper surface of the battery module, a refrigerant transport pipe 40 configured to supply and collect a refrigerant to and from the cooling channel 30, and an upper protection cover 50 and a lower protection cover 60 configured to wrap the cooling channel 30 in order to protect the cooling channel. Here, although not shown, another battery module is loaded on the upper surface of the upper protection cover 50 such that the battery modules are stacked in multiple stages, whereby efficiency of cooling of the battery modules is improved and leakage of the refrigerant in the cooling channel 30 through the upper protection cover 50 and the lower protection cover 60 is prevented.

In the conventional art, as described above, a heat exchange process between the battery module and the refrigerant in the cooling channel 30 is improved, whereby cooling performance is improved, and grooves 51 and 61 are provided to receive the cooling channel 30, whereby space utilization is improved. Since the refrigerant transport pipe 40 configured to supply and collect the refrigerant to and from the cooling channel 30 is exposed to the outside, however, there is a problem in that the volume of the battery pack is large.

In addition, since the refrigerant transport pipe 40, in which the refrigerant flows, is exposed to the outside, the refrigerant may leak due to damage to the refrigerant transport pipe when external impact is applied thereto, which may lead to a serious accident.

### Prior Art Document

(Patent Document 1) Japanese Patent Application Publication No. 2016-029660

### DISCLOSURE

### Technical Problem

The present invention has been made in view of the above problems, and it is an object of the present invention to provide a battery pack configured such that heat generated from battery modules stacked in multiple stages is effectively discharged, whereby safety of the battery pack is improved.

It is another object of the present invention to provide a battery pack configured such that leakage of a refrigerant from the battery pack is minimized.

It is another object of the present invention to provide a battery pack configured such that an increase in volume of the battery pack due to various parts configured to perform cooling is inhibited.

It is a further object of the present invention to provide a battery pack configured such that leakage of a refrigerant is restricted even in the case in which a frame is damaged due to external impact.

### Technical Solution

In order to accomplish the above objects, a battery pack according to the present invention includes at least one battery module and a pack case configured to receive the battery module therein, wherein the battery module includes a first battery module and a second battery module vertically stacked above the first battery module, a first cooler configured to discharge heat generated from the first battery module is located between an inside upper surface of the bottom surface of the pack case and the first battery module, and a second cooler configured to discharge heat generated from the second battery module is provided between the first battery module and the second battery module.

Also, in the battery pack according to the present invention, the pack case may include a front frame, a rear frame, and a pair of side frames configured to connect the front frame and the rear frame to each other, and each of the pair of side frames may be provided with a refrigerant circulation channel configured to supply and collect a refrigerant to and from the first cooler.

Also, in the battery pack according to the present invention, the front frame may be provided with a refrigerant introduction port and a refrigerant discharge port spaced apart from each other by a predetermined distance, and a refrigerant transfer pipe configured to communicate with the refrigerant circulation channel may be connected to each of the refrigerant introduction port and the refrigerant discharge port.

Also, in the battery pack according to the present invention, an air circulation channel may be located adjacent the refrigerant circulation channel of the side frame so as to be parallel to the refrigerant circulation channel.

Also, in the battery pack according to the present invention, the air circulation channel may be provided with at least one incision portion configured to allow external air to pass therethrough.

Also, in the battery pack according to the present invention, the first cooler may include a a first lower plate and a first upper plate configured to provide a space in which a refrigerant is circulated and a first heat sink including a first refrigerant inlet and a first refrigerant outlet coupled to the refrigerant circulation channel, and a bottom surface of the side frame may be provided with fastening holes connected to the first refrigerant inlet and the first refrigerant outlet.

Also, in the battery pack according to the present invention, the second cooler may include a second heat sink, a lower protection cover located under the second heat sink, an upper protection cover located on the second heat sink, and a coupling band located along edges of the lower protection cover and the upper protection cover in a state of receiving the second heat sink.

Also, in the battery pack according to the present invention, the coupling band may be formed by cold metal transfer welding.

Also, in the battery pack according to the present invention, the second cooler may include a second heat sink, a lower protection cover located under the second heat sink, and an upper protection cover located on the second heat sink, and a sealing gasket may be between edges of the lower protection cover and the upper protection cover.

Also, in the battery pack according to the present invention, the second heat sink may include a second heat sink body, a second L-shaped refrigerant inlet configured to supply a second refrigerant to the second heat sink body, and a second L-shaped refrigerant outlet configured to discharge the second refrigerant, and the lower protection cover may be provided with a pair of bent pipes configured to receive the second refrigerant inlet and the second refrigerant outlet, respectively.

In addition, the present invention may provide a device having mounted therein the battery pack having one or more of the features mentioned above.

### Advantageous Effects

As is apparent from the above description, a battery pack including battery modules stacked in multiple stages according to the present invention has a merit in that a cooling unit is also provided between the vertically stacked battery modules, whereby cooling efficiency is improved.

In addition, the battery pack including the battery modules stacked in multiple stages according to the present invention has an advantage in that an upper protection cover and a lower protection cover wrap a second heat sink in order to protect the second heat sink, whereby impact resistance is high and refrigerant leakage is minimized.

In addition, the battery pack including the battery modules stacked in multiple stages according to the present invention has a merit in that a refrigerant circulation channel is provided in a side frame, whereby it is possible to minimize leakage of a refrigerant even in the case in which external impact is applied thereto.

Furthermore, the battery pack including the battery modules stacked in multiple stages according to the present invention has an advantage in that an air circulation channel is further provided in the side frame along the refrigerant circulation channel, whereby it is possible to improve cooling efficiency and to reduce the overall weight of the battery pack.

### DESCRIPTION OF DRAWINGS

FIG. 1 is a perspective view of a conventional battery module.

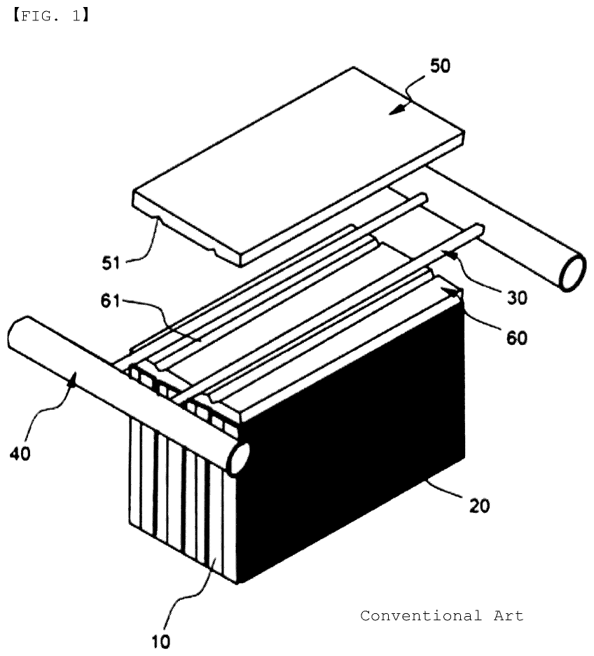

FIG. 2 is a perspective view of a battery pack according to a first preferred embodiment of the present invention.

FIG. 3 is an exploded perspective view of the battery pack according to the first preferred embodiment of the present invention.

FIG. 4 is a sectional view taken along line A-A′ of FIG. 2.

FIG. 5 is a perspective view showing a side frame according to a first preferred embodiment of the present invention.

FIG. 6 is a perspective view illustrating coupling of the side frame according to the first preferred embodiment of the present invention.

FIG. 7 is an exploded perspective view illustrating a battery module and a first cooling unit of FIG. 3.

FIG. 8 is an exploded perspective view illustrating the first cooling unit of FIG. 7.

FIG. 9 is an exploded perspective view of a second cooling unit according to a first preferred embodiment of the present invention.

FIG. 10 is an exploded perspective view of a second cooling unit according to a second preferred embodiment of the present invention.

FIG. 11 is a partial perspective view illustrating a battery pack according to a third preferred embodiment of the present invention.

### BEST MODE

Now, preferred embodiments of the present invention will be described in detail with reference to the accompanying drawings such that the preferred embodiments of the present invention can be easily implemented by a person having ordinary skill in the art to which the present invention pertains. In describing the principle of operation of the preferred embodiments of the present invention in detail, however, a detailed description of known functions and configurations incorporated herein will be omitted when the same may obscure the subject matter of the present invention.

In addition, the same reference numbers will be used throughout the drawings to refer to parts that perform similar functions or operations. In the case in which one part is said to be connected to another part in the entire specification, not only may the one part be directly connected to the other part, but also, the one part may be indirectly connected to the other part via a further part. In addition, that a certain element is included does not mean that other elements are excluded, but means that such elements may be further included unless mentioned otherwise.

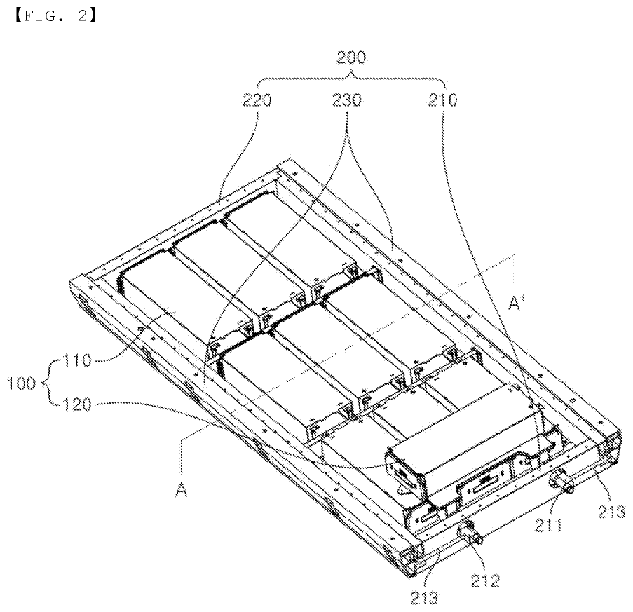

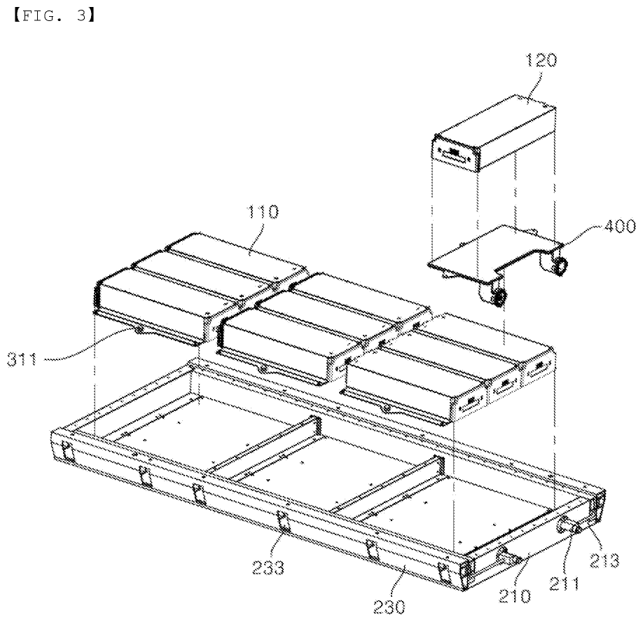

FIG. 2 is a perspective view of a battery pack according to a first preferred embodiment of the present invention, and FIG. 3 is an exploded perspective view of the battery pack according to the first preferred embodiment of the present invention.

Referring to FIGS. 2 and 3, the battery pack according to the present invention includes a battery module 100, a pack case 200 configured to receive the battery module 100 therein, and a first cooling unit 300 and a second cooling unit 400 configured to remove heat generated from the battery module 100.

When describing the battery module 100, first, the battery module 100 includes a plurality of first battery modules 110 seated on the bottom surface of the pack case 200 and a second battery module 120 located above the first battery modules 110.

Here, each of the first battery module 110 and the second battery module 120 may include at least one unit cell, and the unit cell may include an electrode assembly and a cell case configured to receive the electrode assembly therein. The electrode assembly may be a jelly-roll type electrode assembly, which is configured to have a structure in which a long sheet type positive electrode and a long sheet type negative electrode are wound in the state in which a separator is interposed therebetween, a stacked type electrode assembly including unit cells, each of which is configured to have a structure in which a rectangular positive electrode and a rectangular negative electrode are stacked in the state in which a separator is interposed therebetween, a stacked and folded type electrode assembly, which is configured to have a structure in which unit cells are wound using a long separation film, or a laminated and stacked type electrode assembly, which is configured to have a structure in which unit cells are stacked in the state in which a separator is interposed therebetween and are then attached to each other. However, the present invention is not limited thereto. It is preferable for the electrode assembly according to the present invention to be a stacked and folded type electrode assembly or a laminated and stacked type electrode assembly, which has lowest physical stress when a curved module is formed.

The electrode assembly is received in the cell case. The cell case is generally configured to have a laminate sheet structure including an inner layer, a metal layer, and an outer layer. The inner layer is disposed in direct contact with the electrode assembly, and therefore the inner layer must exhibit high insulation properties and high resistance to an electrolytic solution. In addition, the inner layer must exhibit high sealability in order to hermetically seal the cell case from the outside, i.e. a thermally-bonded sealed portion between inner layers must exhibit excellent thermal bonding strength. The inner layer may be made of a material selected from among a polyolefin-based resin, such as polypropylene, polyethylene, polyethylene acrylate, or polybutylene, a polyurethane resin, and a polyimide resin, which exhibit excellent chemical resistance and high sealability. However, the present invention is not limited thereto, and polypropylene, which exhibits excellent mechanical-physical properties, such as tensile strength, rigidity, surface hardness, and resistance to impact strength, and excellent chemical resistance, is the most preferably used.

The metal layer, which is disposed so as to abut the inner layer, corresponds to a barrier layer configured to prevent moisture or various kinds of gas from permeating into the battery from the outside. An aluminum thin film, which is light and easily shapeable, may be used as a preferred material for the metal layer.

The outer layer is provided on the other surface of the metal layer. The outer layer may be made of a heat-resistant polymer that exhibits excellent tensile strength, resistance to moisture permeation, and resistance to air transmission such that the outer layer exhibits high heat resistance and chemical resistance while protecting the electrode assembly. As an example, the outer layer may be made of nylon or polyethylene terephthalate. However, the present invention is not limited thereto.

Although a total of 10 battery modules 100, i.e. nine first battery modules 110 and one second battery module 120, is shown as being received in the figures, which is merely an illustration, the number of battery modules may be changed.

The pack case 200, which is configured to receive the battery modules 100 therein and to protect the battery modules 100 from external impact, includes a front frame 210, a rear frame 220, and a pair of side frames 230.

Specifically, a pair of a refrigerant introduction port 211 and a refrigerant discharge port 212 is fixed to the front frame 210 in a state of being spaced apart from each other by a predetermined distance, and a pair of refrigerant transfer pipes 213 is connected to these ports so as to extend toward the side frames 230.

Consequently, a refrigerant, cooled to a predetermined temperature, from the outside is injected into the refrigerant introduction port 211 and then flows along the refrigerant transfer pipe 213 connected to the refrigerant introduction port 211. The refrigerant, heated to a predetermined temperature as a result of absorbing heat of the first battery modules 110, is discharged through the other refrigerant transfer pipe 213 and the refrigerant discharge port 212. After being cooled to a predetermined temperature, the refrigerant is resupplied.

In addition, some of the refrigerant introduced into the refrigerant introduction port 211 moves to the second cooling unit 400, absorbs heat generated from the second battery module 120, is discharged via the refrigerant discharge port 212, is cooled, and is resupplied.

Here, the pair of the refrigerant transfer pipes 213 supplies and collects the refrigerant to and from the side frames 230 and a second heat sink 410. A detailed description related thereto will be given below.

Meanwhile, a plurality of partition walls may be provided on the bottom surface of the pack case 200 such that the battery modules 100 are spaced apart from each other by a predetermined distance.

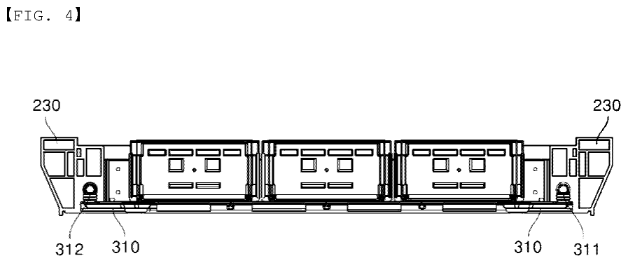

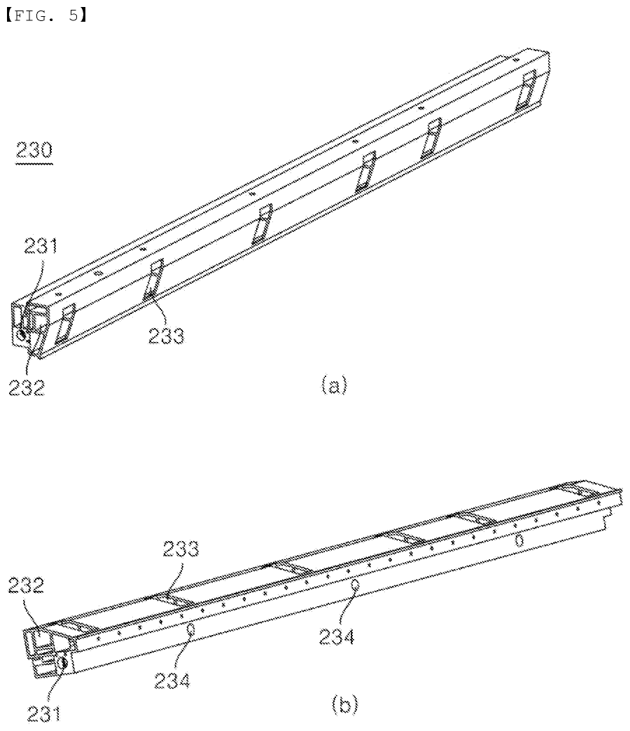

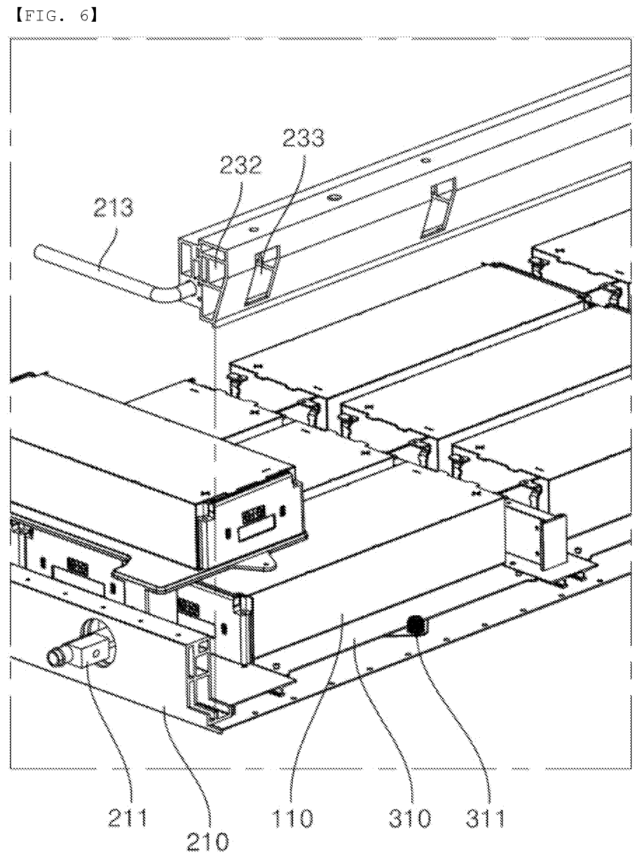

FIG. 4 is a sectional view taken along line A-A′ of FIG. 2, FIG. 5 is a perspective view showing a side frame according to a first preferred embodiment of the present invention, and FIG. 6 is a perspective view illustrating coupling of the side frame according to the first preferred embodiment of the present invention.

Referring to FIGS. 4 to 6, the pair of side frames 230 according to the present invention is spaced apart from each other by a predetermined distance in order to connect the front frame 210 and the rear frame 220 to each other, and each side frame 230 is provided with a refrigerant circulation channel 231 connected to a corresponding one of the refrigerant transfer pipes 213, an air circulation channel 232, an incision portion 233, and a fastening hole 234.

First, the refrigerant circulation channel 231 connected to one side of the refrigerant transfer pipe 213 is configured to have a shape extending through the side frame 230 in a longitudinal direction thereof. Consequently, a cool refrigerant to be supplied to a first heat sink 310 flows in the refrigerant circulation channel 231 connected to the refrigerant transfer pipe 213 communicating with the refrigerant introduction port 211, and a refrigerant heated to a predetermined temperature as a result of heat absorption moves in the refrigerant circulation channel 231 connected to the refrigerant transfer pipe 213 communicating with the refrigerant discharge port 212.

Conventionally, the refrigerant circulation channel is separately manufactured and is then connected to the side surface or the bottom surface of the pack case, and therefore the refrigerant circulation channel may be easily damaged due to external impact. Furthermore, there is a problem in that a refrigerant that leaks from the refrigerant circulation channel as a result of damage to the refrigerant circulation channel may cause a new event.

In contrast, the refrigerant circulation channel 231 according to the present invention is provided in the side frame 230, and therefore there are advantages in that a danger of damage to the refrigerant circulation channel due to external impact may be minimized and the overall volume of the battery pack may be reduced.

The air circulation channel 232 is located in the state in which a separation wall is disposed between the air circulation channel and the refrigerant circulation channel 231 such that no refrigerant leaks into the air circulation channel. At this time, the air circulation channel extends long parallel to the refrigerant circulation channel 231 such that the refrigerant moving in the refrigerant circulation channel 231 is cooled as naturally as possible.

Furthermore, the air circulation channel 232 is provided with at least one incision portion 233, through which external air may pass, whereby more efficient cooling is possible. That is, since the air circulation channel 232 is further provided in the side frame 230 along the refrigerant circulation channel 231, it is possible to rapidly cool the battery pack and to reduce the overall weight of the battery pack.

Meanwhile, each of the pair of side frames 230 is provided in the bottom surface thereof with at least one fastening hole 234 configured to communicate with the refrigerant circulation channel 231, more specifically fastening holes 234 equal in number to first refrigerant inlets 311 or first refrigerant outlets 312 of the first heat sink 310 located under the battery modules 100.

For example, for the side frame 230 sequentially connected to the refrigerant introduction port 211 and the refrigerant transfer pipe 213, the fastening holes 234 formed in the bottom surface of the side frame 230 are respectively fixed to the first refrigerant inlets 311 of the first heat sink 310 by fastening. Consequently, a refrigerant introduced into the refrigerant introduction port 211 sequentially moves along the refrigerant transfer pipe 213 and the refrigerant circulation channel 231 and is then supplied to the first refrigerant inlets 311 of the first heat sink 310.

In the same manner, the other side frame 230 connected to the first refrigerant discharge port 212 and the refrigerant transfer pipe 213 has the same coupling structure as described above, and a heated refrigerant is circulated in the order of the first refrigerant outlets 312 of the first heat sink 310, the refrigerant transfer pipe 213, and the refrigerant discharge port 212.

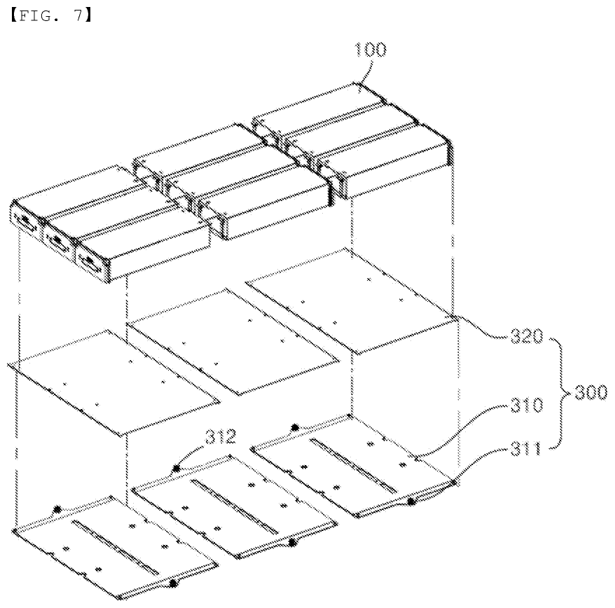

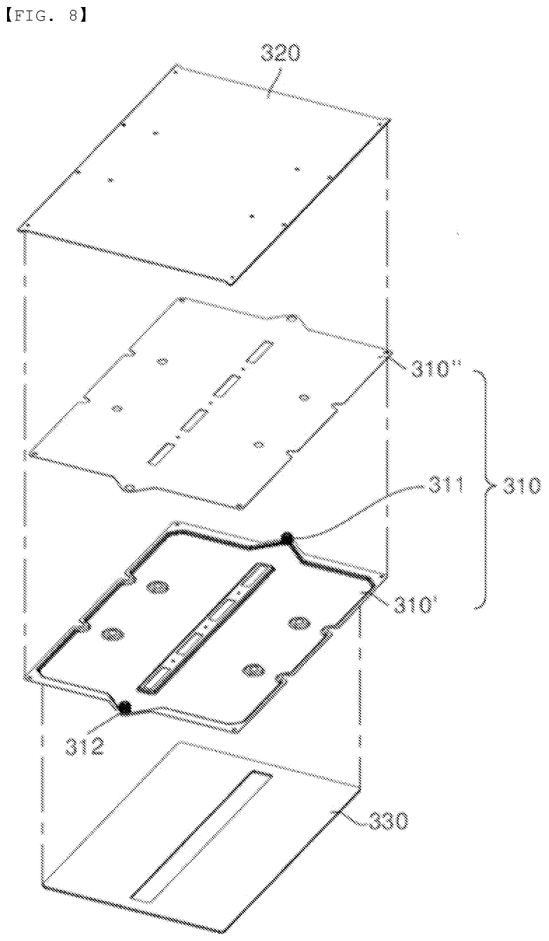

FIG. 7 is an exploded perspective view illustrating the battery module and the first cooling unit of FIG. 3, and FIG. 8 is an exploded perspective view illustrating the first cooling unit of FIG. 7.

The first cooling unit 300, which is configured to remove heat generated from the first battery modules 110, is located between the battery module 100 and an inside upper surface of the pack case 200, and includes a first heat sink 310 and a first heat dissipation plate 320 located between the first heat sink 310 and the first battery modules 110.

Specifically, the first heat sink 310 is constituted by a pair of a first lower plate 310′ and a first upper plate 310″ in order to provide a space in which a refrigerant is circulated.

Here, the first lower plate 310′ is provided with a pair of a first refrigerant inlet 311 and a first refrigerant outlet 312 facing each other, to which the fastening holes 234 formed in the bottom surfaces of the side frames 230 are coupled, as previously described.

Meanwhile, the first heat dissipation plate 320 is located between the first heat sink 310 and the first battery modules 110, and a second heat dissipation plate 330 is located under the first heat sink 310, whereby heat generated from the first battery modules 110 is transmitted to the first heat sink 310.

Particularly, since the first heat dissipation plate 320 and the second heat dissipation plate 330 are located at the upper surface and the lower surface of the first heat sink 310, respectively, so as to wrap the first heat sink 310 once more, there is an advantage in that, even in the case in which refrigerant leakage occurs, it is possible to prevent the refrigerant from permeating into the battery pack.

It is preferable for each of the first heat sink 310, the first heat dissipation plate 320, and the second heat dissipation plate 330 to be made of a material that exhibits high thermal conductivity, such as aluminum.

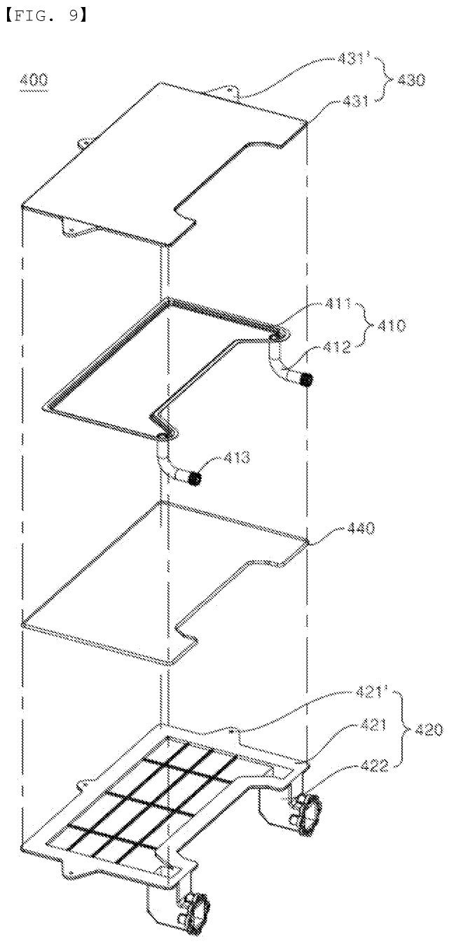

FIG. 9 is an exploded perspective view of a second cooling unit according to a first preferred embodiment of the present invention.

The second cooling unit 400 is located between the upper surfaces of the first battery modules 110 and the lower surface of the second battery module 120, and includes a second heat sink 410, a lower protection cover 420, an upper protection cover 430, and a coupling band 440.

Specifically, the second heat sink 410 includes a second heat sink body 411 configured to provide a space in which a refrigerant is circulated, a second refrigerant inlet 412, and a second refrigerant outlet 413.

Here, the second refrigerant inlet 412 and the second refrigerant outlet 413 are located at one side of the second heat sink body 411 so as to be spaced apart from each other by a predetermined distance, and each thereof has an appropriately L-shape. As previously described, the second refrigerant inlet 412 is coupled to the refrigerant introduction port 211, and the second refrigerant outlet 413 is coupled to the refrigerant discharge port 212.

The lower protection cover 420 includes a lower protection cover body 421 and an L-shaped bent pipe 422, and is configured to physically protect the second heat sink 410 from external impact and to fundamentally prevent the refrigerant from flowing into the battery pack even in the case in which the refrigerant leaks from the second heat sink 410 by various causes, thereby preventing occurrence of a secondary event.

Meanwhile, the lower protection cover body 421 may be provided at the edge thereof with at least one first fastening portion 421′, which is fixed to a second fastening portion of an upper protection cover body, a description of which will follow.

The upper protection cover 430 includes an upper protection cover body 431 and at least one second fastening portion 431′. That is, the upper protection cover 430 is located in the state in which the second heat sink 410 is seated on the upper protection cover body 431, whereby it is possible to more securely protect the second heat sink 410.

The coupling band 440 is configured to couple the lower protection cover body 421 and the upper protection cover body 431 to each other. As an example, the coupling band 440 may be formed along an edge joint at which the lower protection cover body 421 and the upper protection cover body 431 join each other by cold metal transfer (CMT) welding.

Of course, the lower protection cover body 421 and the upper protection cover body 431 may be joined to each other after being fastened to each other by bolting through the first fastening portion 421′ and the second fastening portion 431′, or only cold metal transfer (CMT) welding may be performed in the state in which the first fastening portion 421′ and the second fastening portion 431′ are omitted.

Meanwhile, it is preferable for each of the second heat sink 410, the lower protection cover 420, and the upper protection cover 430 to be made of a material that exhibits high thermal conductivity, such as aluminum.

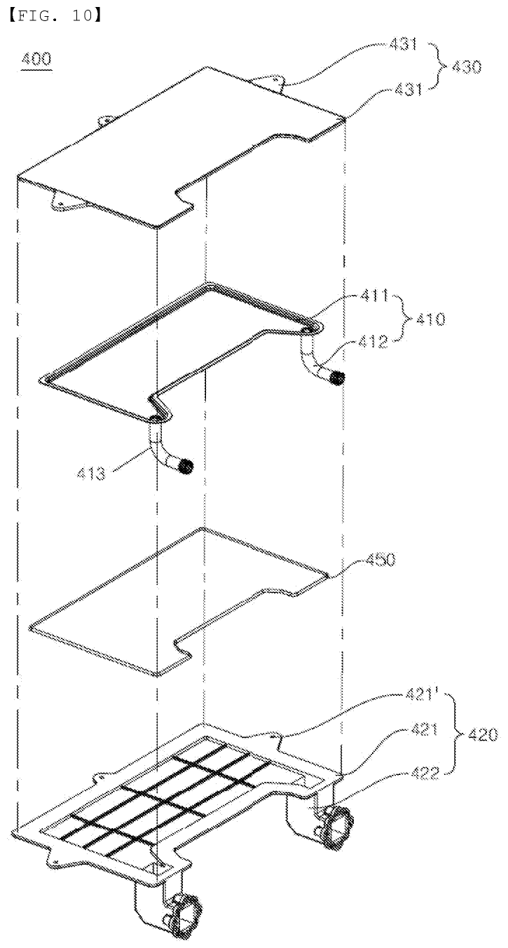

FIG. 10 is an exploded perspective view of a second cooling unit according to a second preferred embodiment of the present invention.

Referring to FIG. 10, the second cooling unit 400 according to the second embodiment is identical to the second cooling unit 400 according to the first embodiment except that a sealing gasket 450 is provided instead of the coupling band 440.

When describing the sealing gasket 450 of the second cooling unit 400 according to the second embodiment, the sealing gasket 450 may be formed along the edge between the lower protection cover body 421 and the upper protection cover body 431, whereby it is possible to securely prevent refrigerant leakage from the second cooling unit 400 even in the case in which the second heat sink 410 is damaged. As an example, the sealing gasket may be made of a heat-resistant rubber material; however, the material for the sealing gasket is not particularly restricted as long as the sealing gasket is capable of performing the same function.

Although not shown in the figure, a groove (not shown) configured to receive the sealing gasket 450 may be further formed in at least one of the lower protection cover body 421 and the upper protection cover body 431.

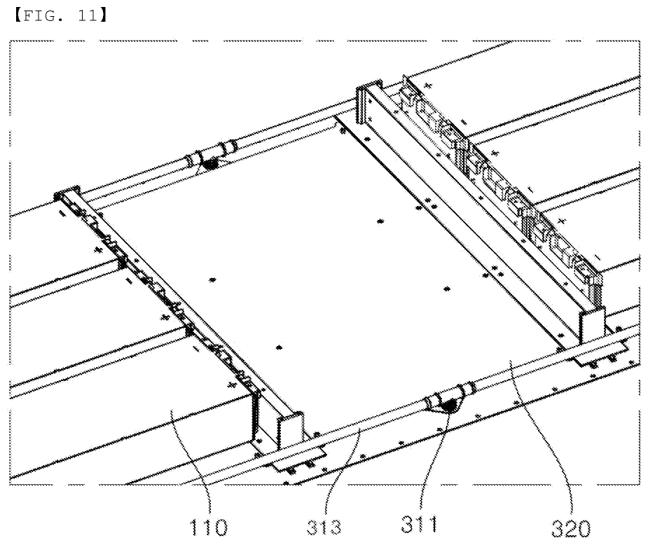

FIG. 11 is a partial perspective view illustrating a battery pack according to a third preferred embodiment of the present invention.

Referring to FIG. 11, the battery pack according to the third preferred embodiment of the present invention may further include a refrigerant circulation pipe 313.

In the embodiment described with reference to FIGS. 2 to 10, a refrigerant is circulated along the refrigerant circulation channel 231 of the side frame 230, whereas the refrigerant circulation pipe 313 is further provided in the third embodiment.

That is, the refrigerant transfer pipe 213 and the refrigerant circulation pipe 313 are connected to each other such that a refrigerant introduced into or discharged from the refrigerant transfer pipe 213 passes though the refrigerant circulation pipe 313, and the refrigerant circulation pipe 313 is disposed in the refrigerant circulation channel 231 of the side frame 230.

Since the refrigerant circulation pipe 313 is located in the refrigerant circulation channel 231, as described above, it is possible to securely prevent leakage of the refrigerant, thus inhibiting occurrence of an event, even in the case in which the side case 230 is damaged due to external impact.

The present invention may provide a device having mounted therein the battery pack having at least one of the features described above. The device may be an electronic device including a large-capacity battery, such as an electric vehicle, a hybrid electric vehicle, or a plug-in hybrid electric vehicle.

Those skilled in the art to which the present invention pertains will appreciate that various applications and modifications are possible within the category of the present invention based on the above description.

### DESCRIPTION OF REFERENCE NUMERALS

100: Battery module
110: First battery module
120: Second battery module
200: Pack case
210: Front frame
211: Refrigerant introduction port 212: Refrigerant discharge port
213: Refrigerant transfer pipe
220: Rear frame
230: Side frame
231: Refrigerant circulation channel
232: Air circulation channel
233: Incision portion
234: Fastening hole
300: First cooling unit
310: First heat sink
310′: First lower plate
310″: First upper plate
311: First refrigerant inlet 312: First refrigerant outlet
313: Refrigerant circulation pipe
320: First heat dissipation plate
330: Second heat dissipation plate
400: Second cooling unit
410: Second heat sink
411: Second heat sink body 412: Second refrigerant inlet
413: Second refrigerant outlet
420: Lower protection cover
421: Lower protection cover body
421′: First fastening portion
422: Bent pipe
430: Upper protection cover
431: Upper protection cover body
431′: Second fastening portion
440: Coupling band
450: Sealing gasket

1. A battery pack comprising battery modules stacked in multiple stages, the battery pack comprising:
at least one battery module; and
a pack case configured to receive the battery module therein, wherein
the battery module comprises a first battery module and a second battery module vertically stacked above the first battery module,
wherein a first cooler configured to discharge heat generated from the first battery module is located between an inside upper surface of a bottom surface of the pack case and the first battery module, and
wherein a second cooler configured to discharge heat generated from the second battery module is provided between the first battery module and the second battery module.

2. The battery pack according to claim 1, wherein the pack case comprises a front frame, a rear frame, and a pair of side frames configured to connect the front frame and the rear frame to each other, and
wherein each of the pair of side frames is provided with a refrigerant circulation channel configured to supply and collect a refrigerant to and from the first cooler.

3. The battery pack according to claim 2, wherein the front frame is provided with a refrigerant introduction port and a refrigerant discharge port spaced apart from each other by a predetermined distance, and
wherein a refrigerant transfer pipe configured to communicate with the refrigerant circulation channel is connected to each of the refrigerant introduction port and the refrigerant discharge port.

4. The battery pack according to claim 2, wherein an air circulation channel is located adjacent the refrigerant circulation channel of the side frame so as to be parallel to the refrigerant circulation channel.

5. The battery pack according to claim 4, wherein the air circulation channel is provided with at least one incision portion configured to allow external air to pass therethrough.

6. The battery pack according to claim 4, wherein the first cooler comprises:
a first lower plate and a first upper plate configured to provide a space in which a refrigerant is circulated; and
a first heat sink comprising a first refrigerant inlet and a first refrigerant outlet coupled to the refrigerant circulation channel, and
wherein a bottom surface of the side frame is provided with fastening holes connected to the first refrigerant inlet and the first refrigerant outlet.

7. The battery pack according to claim 1, wherein the second cooler comprises:
a second heat sink;
a lower protection cover located under the second heat sink;
an upper protection cover located on the second heat sink; and
a coupling band located along edges of the lower protection cover and the upper protection cover in a state of receiving the second heat sink.

8. The battery pack according to claim 7, wherein the coupling band is formed by cold metal transfer welding.

9. The battery pack according to claim 1, wherein the second cooler comprises:
a second heat sink;
a lower protection cover located under the second heat sink; and
an upper protection cover located on the second heat sink; and
a sealing gasket between edges of the lower protection cover and the upper protection cover.

10. The battery pack according to claim 7, wherein the second heat sink comprises:
a second heat sink body;
a second L-shaped refrigerant inlet configured to supply a second refrigerant to the second heat sink body; and
a second L-shaped refrigerant outlet configured to discharge the second refrigerant,
wherein the lower protection cover is provided with a pair of bent pipes configured to receive the second refrigerant inlet and the second refrigerant outlet, respectively.

11. A device comprising the battery pack according to claim 1.
